(19) United States
(12) Patent Application Publication
(10) Pub. No.: US 2023/0026139 A1
(43) Pub. Date: Jan. 26, 2023

(54) System for Monitoring a Device

(71) Applicant: ABB Schweiz AG, Baden (CH)

(72) Inventors: Joerg Ostrowski, Zürich (CH); Stephan Wildermuth, Laudenbach (DE); Ralf Gitzel, Mannheim (DE); Patrik Reto Kaufmann, Baden (CH); Joerg Gebhardt, Mainz (DE); Kai Koenig, Walldorf (DE); Boguslaw Samul, Krakow (PL)

(73) Assignee: ABB Schweiz AG, Baden (CH)

(21) Appl. No.: 17/868,975

(22) Filed: Jul. 20, 2022

(30) Foreign Application Priority Data
Jul. 20, 2021 (EP) 21186807.0

(51) Int. Cl. G01J 5/80

(52) U.S. Cl. CPC G01J 5/80; G01J 2005/0077

(57) ABSTRACT

A system and method includes at least one temperature sensor, a processing unit, and an output unit. The temperature sensor acquires a temperature measurement at a first location of an operational device, which first location is in thermal contact with a second location of the operational device. The processing unit selects a simulated temperature distribution of the first location of a simulated device from a plurality of simulated temperature distributions of the first location and compares the temperature measurement with simulated temperature distributions of the first location, and determines whether a hot spot exists or is developing at the second location. The determination comprises utilization of a correlation between the simulated temperature distribution of the first location and the second location for the selected simulated temperature distribution of the first location of the simulated device.

### CROSS-REFERENCE TO RELATED APPLICATIONS

This patent application claims priority to European Patent Application No. 21186807.0, filed on Jul. 20, 2021, which is incorporated herein in its entirety by this reference.

### FIELD OF THE DISCLOSURE

The present invention relates a system for monitoring a device and to a method of monitoring a device.

### BACKGROUND OF THE INVENTION

The temperature of a power device (for example, a low power, medium power or high voltage switchgear) needs to stay within device specific limits to avoid damage from thermal stress.

Temperature monitoring, for example using measurements with infrared (IR) sensors is used to control that these limits are adhered to.

The temperature can be monitored with a sensor but only at positions that are accessible for the sensor (measurable points meas-pt). Other positions or locations can be more important locations (important-pt) of interest, in that they could have higher temperature and be more likely to lead to device failure, but are often not accessible, i.e. hidden for the sensor.

The temperature at these most important points, positions or locations can therefore not directly be monitored by sensors alone.

### BRIEF SUMMARY OF THE INVENTION

In a first aspect, there is provided a system for monitoring a device, the system comprising: at least one temperature sensor; a processing unit; and an output unit.

The at least one temperature sensor is configured to acquire at least one temperature measurement at a first location of an operational device, and the first location is in thermal contact with a second location of the operational device. The at least one temperature sensor is configured to provide the at least one temperature measurement to the processing unit. The processing unit is configured to select a simulated temperature distribution of the first location of the simulated device from a plurality of simulated temperature distributions of the first location of the simulated device. The selection comprises a comparison of the at least one temperature measurement with the plurality of simulated temperature distributions of the first location. The plurality of simulated temperature distributions of the first location each relate to a different situation with respect to simulated operation of the simulated device. For each of the different situations there is a correlation between a simulated temperature distribution of the first location and a simulated temperature at the second location of the simulated device. The processing unit is configured to determine that a hot spot exists or is developing at the second location of the operational device comprising utilization of the correlation between the simulated temperature distribution of the first location and the second location for the selected simulated temperature distribution of the first location of the simulated device. The output unit is configured to output an indication of a fault at the second location of the operational device.

In an example, the temperature measurement can be at one location or a number of different locations. Thus, a temperature measurement at one location can be used to select a simulated correlation between that location where a measurement can be made to a second location where a measurement is difficult to make can be utilized to determine if there is a hot spot. However, a number of temperature measurements at different locations can be used to determine a number of simulated temperature distributions for the same locations, and a simulated correlation between simulated temperatures at these first locations and a second location, where it is physically difficult to take measurements can be used to determine if there is a problem at this hard to measure location.

According to an example, the at least one temperature sensor comprises one or more infrared cameras, one or more Surface Acoustic Wave sensor, or one or more RFID sensors.

According to an example, the at least one temperature measurement comprises a plurality of temperature measurements, and wherein the plurality of temperature measurements were acquired at the same time.

According to an example, the at least one temperature sensor is an infrared camera, and wherein the the at least one temperature measurement comprises an infrared image of the first location.

According to an example, the plurality of simulated temperature distributions are simulated in a process that comprises utilization of finite element analysis.

According to an example, the correlation between the simulated temperature distribution of the first location and the simulated temperature at the second location of the simulated device for each of the different situations was determined through utilization of finite element analysis.

According to an example, the comparison of the at least one temperature measurement with the plurality of simulated temperature distributions comprises utilization of a matrix norm or a machine learning algorithm implemented by the processing unit.

In a second aspect, there is provided a method for monitoring a device comprising: a) acquiring by at least one temperature sensor at least one temperature measurement at a first location of an operational device, and wherein the first location is in thermal contact with a second location of the operational device; b)providing the at least one temperature sensor to a processing unit; c) selecting by the processing unit a simulated temperature distribution of the first location of the simulated device from a plurality of simulated temperature distributions of the first location of the simulated device, wherein the selecting comprises comparing the at least one temperature measurement with the plurality of simulated temperature distributions of the first location, wherein the plurality of simulated temperature distributions of the first location each relate to a different situation with respect to simulated operation of the simulated device, and wherein for each of the different situations there is a correlation between a simulated temperature distribution of the first location and a simulated temperature at the second location of the simulated device; d) determining by the processing unit that a hot spot exists or is developing at the second location of the operational device, and wherein the determining comprises utilizing the correlation between the simulated temperature distribution of the first location and the second location for the selected simulated temperature distribution of the first location of the simulated device; and e) outputting by an output unit an indication of a fault at the second location of the operational device.

According to an example, the at least one temperature sensor comprises one or more infrared cameras, one or more Surface Acoustic Wave sensor, or one or more RFID sensors.

According to an example, the at least one temperature measurement comprises a plurality of temperature measurements, and wherein the plurality of temperature measurements were acquired at the same time.

According to an example, the at least one temperature sensor is an infrared camera, and wherein the the at least one temperature measurement comprises an infrared image of the first location.

According to an example, the plurality of simulated temperature distributions are simulated in a process that comprises utilization of finite element analysis.

According to an example, the correlation between the simulated temperature distribution of the first location and the simulated temperature at the second location of the simulated device for each of the different situations was determined through utilization of finite element analysis.

According to an example, the comparing the at least one temperature measurement with the plurality of simulated temperature distributions comprises utilizing a matrix norm or a machine learning algorithm implemented by the processing unit.

The above aspects and examples will become apparent from and be elucidated with reference to the embodiments described hereinafter.

### BRIEF DESCRIPTION OF THE SEVERAL VIEWS OF THE DRAWING(S)

Exemplary embodiments will be described in the following with reference to the following drawings.

FIG. 1 shows a representation of monitoring of a device in accordance with the disclosure.

FIG. 2 shows a representation of a measured temperature distribution being used to select a simulated temperature distribution in accordance with the disclosure.

### DETAILED DESCRIPTION OF THE INVENTION

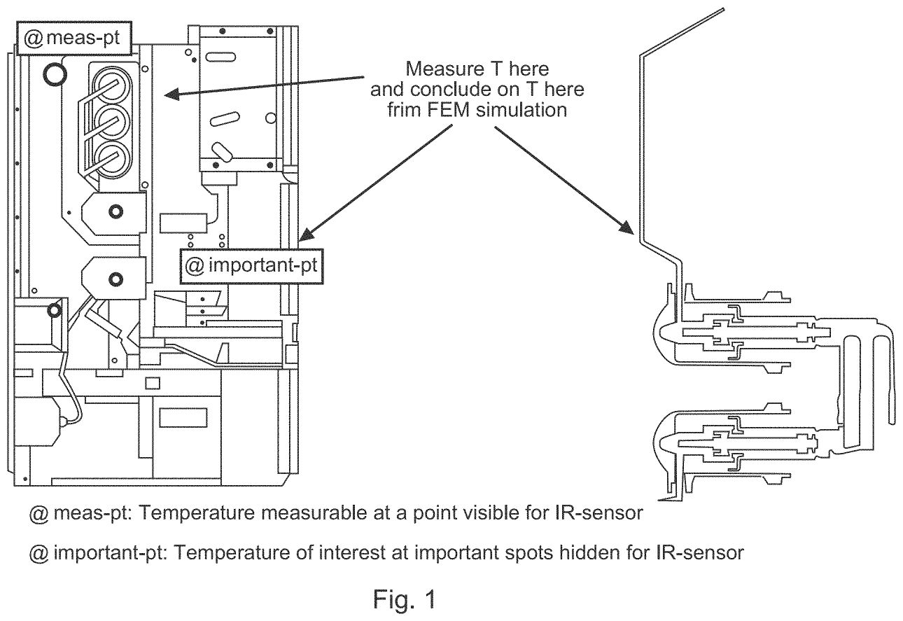

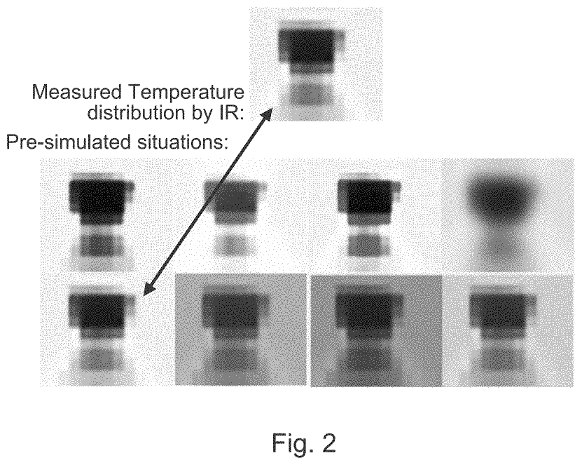

FIGS. 1-2 relate to a system for monitoring a device and to a method for monitoring a device.

In an example, the system for monitoring a device comprises at least one temperature sensor, a processing unit, and an output unit. The at least one temperature sensor is configured to acquire at least one temperature measurement at a first location of an operational device, and the first location is in thermal contact with a second location of the operational device. The at least one temperature sensor is configured to provide the at least one temperature measurement to the processing unit. The processing unit is configured to select a simulated temperature distribution of the first location of the simulated device from a plurality of simulated temperature distributions of the first location of the simulated device. The selection comprises a comparison of the at least one temperature measurement with the plurality of simulated temperature distributions of the first location. The plurality of simulated temperature distributions of the first location each relate to a different situation with respect to simulated operation of the simulated device, and for each of the different situations there is a correlation between a simulated temperature distribution of the first location and a simulated temperature at the second location of the simulated device. The processing unit is configured to determine that a hot spot exists or is developing at the second location of the operational device. The determination comprises utilization of the correlation between the simulated temperature distribution of the first location and the second location for the selected simulated temperature distribution of the first location of the simulated device (that was selected using the acquired at least one temperature measurement at the first location). The output unit is configured to output an indication of a fault at the second location of the operational device.

In an example, the temperature measurement can be at one location or a number of different locations. Thus, a temperature measurement at one location can be used to select a simulated correlation between that location where a measurement can be made to a second location where a measurement is difficult to make can be utilized to determine if there is a hot spot. However, a number of temperature measurements at different locations can be used to determine a number of simulated temperature distributions for the same locations, and a simulated correlation between simulated temperatures at these first locations and a second location, where it is physically difficult to take measurements can be used to determine if there is a problem at this hard to measure location.

According to an example, the at least one temperature sensor comprises one or more infrared cameras, one or more Surface Acoustic Wave sensor, or one or more RFID sensors.

According to an example, the at least one temperature measurement comprises a plurality of temperature measurements, and wherein the plurality of temperature measurements were acquired at the same time.

According to an example, the at least one temperature sensor is an infrared camera, and wherein the at least one temperature measurement comprises an infrared image of the first location.

According to an example, the plurality of simulated temperature distributions are simulated in a process that comprises utilization of finite element analysis.

According to an example, the correlation between the simulated temperature distribution of the first location and the simulated temperature at the second location of the simulated device for each of the different situations was determined through utilization of finite element analysis.

According to an example, the comparison of the at least one temperature measurement with the plurality of simulated temperature distributions comprises utilization of a matrix norm or a machine learning algorithm implemented by the processing unit.

In an example, the method for monitoring a device comprises: a) acquiring by at least one temperature sensor at least one temperature measurement at a first location of an operational device, and wherein the first location is in thermal contact with a second location of the operational device; b) providing the at least one temperature sensor to a processing unit; c) selecting by the processing unit a simulated temperature distribution of the first location of the simulated device from a plurality of simulated temperature distributions of the first location of the simulated device, wherein the selecting comprises comparing the at least one temperature measurement with the plurality of simulated temperature distributions of the first location, wherein the plurality of simulated temperature distributions of the first location each relate to a different situation with respect to simulated operation of the simulated device, and wherein for each of the different situations there is a correlation between a simulated temperature distribution of the first location and a simulated temperature at the second location of the simulated device; d) determining by the processing unit that a hot spot exists or is developing at the second location of the operational device, and wherein the determining comprises utilizing the correlation between the simulated temperature distribution of the first location and the second location for the selected simulated temperature distribution of the first location of the simulated device; and e) outputting by an output unit an indication of a fault at the second location of the operational device.

According to an example, the at least one temperature sensor comprises one or more infrared cameras, one or more Surface Acoustic Wave sensor, or one or more RFID sensors.

According to an example, the at least one temperature measurement comprises a plurality of temperature measurements, and wherein the plurality of temperature measurements were acquired at the same time.

According to an example, the at least one temperature sensor is an infrared camera, and wherein the at least one temperature measurement comprises an infrared image of the first location.

According to an example, the plurality of simulated temperature distributions are simulated in a process that comprises utilization of finite element analysis.

According to an example, the correlation between the simulated temperature distribution of the first location and the simulated temperature at the second location of the simulated device for each of the different situations was determined through utilization of finite element analysis.

According to an example, the comparing the at least one temperature measurement with the plurality of simulated temperature distributions comprises utilizing a matrix norm or a machine learning algorithm implemented by the processing unit.

Thus, the new device monitoring technique enables a conclusion to be made as to the temperature at an important, and possibly even critical, but not accessible point of a power device: The temperature is measured at an accessible point by a sensor, for example by an infrared camera or other sensing methods like SAW, RFID. This measurement is then compared to simulations of a variety of situations. If the measurement corresponds to one of the pre-simulated situations, then the temperature at the important/critical point can determined from the simulation of this situation.

It was established that the correlation between the measured temperature by the sensor at a measurement point (meas-Pt) and the temperature at another location that cannot be measured (important-Pt) enables this problem to be overcome. Once this correlation is known, it is possible to conclude the temperature at the important-Pt from the measurement at the meas-Pt.

It was established that such a correlation can sometimes be derived from dedicated experiments during the product design phase. However, the correlation is only known for the measured situations (for example for the specific current that was applied in the experiment, and for specific situations such as connections that are loose or not perfect in a very specific way) and cannot be generalized to other situations or to other devices. Also, experiments take a lot of time and are costly. Also, measurements at the important or critical position or location (important-Pt) is experimentally are not always possible due to this location being inaccessible, and this can apply even in the design phase in the laboratory.

It was realized that instead of measurements, simulations (for example by Finite Elements FEM) can be used to determine the correlation between the measured temperature at the meas-Pt and the temperature at the important-Pt, by simulating the temperature at the measureable location (meas-Pt) and at the hard to measure location (important-Pt) for a series of different situations of current flow, and indeed of different theoretical situations such as different degrees of non-perfect connections etc.

FEM simulations allow an analysis of the entire device and are not limited to accessible positions only. The situations can easily be varied. Thus, the desired correlation can be determined for a much larger number of different situations than with experiments. The devices can also easily be exchanged in the simulations. So once the simulation methodology is established it is far cheaper, more flexible, and more general than experiments to determine the desired correlation.

FIG. 1 shows an example of an overview of the new technique.

The novel monitoring system consists of the following elements:

1. A temperature measurement by a sensor;
2. A series of pre-simulated FEM simulations of different situations; and
3. An algorithm to compare the measured temperature at the measurement point (meas-pt) with the pre-simulated FEM simulations and to decide which of these situations corresponds to the measurement.

The measurement by the sensor results in a temperature distribution at the meas-Pt. In case of an IR-camera it comprises an array of temperatures that corresponds to the number of pixels of the optics of the IR-camera.

Alternatively the temperature distribution meas-Pt may result from several sensors placed at different locations in the switchgear (e.g. compartments) instead of only one IR cameras.

Alternatively the temperature distribution can consist of point-like temperature measurements, e.g. from distributed wireless sensors.

The FEM simulations are coupled electro-thermal simulations. The ohmic losses are computed by solving the Maxwell equations. There are several options to compute the temperature in the thermal part of the simulation:

Either the simple heat-conduction equation is solved. The heat exchange with the environment can be estimated via heat-transfer coefficients at the surface of the device.

Alternatively, a full CFD calculation can be conducted. This is more effort but is only necessary if convection and radiation cannot sufficiently precise be estimated via heat-transfer coefficients.

Several situations can be simulated corresponding to possible failure cases. The simulated temperature distributions at the meas-PT are then compared to the measured temperature distributions by the sensor, see FIG. 2. This comparison can be done for example by a matrix norm, or by a machine learning algorithm. The best match of the pre-simulated situations with the measurement is then taken to be the current state of the device. The temperature at the important-PT can then be looked up in this simulation.

FIG. 2 illustrates the measured and simulated temperature distributions. A comparison of each simulated case with the measured one is being carried out, and the best match is identified.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for monitoring a device, the system comprising:
at least one temperature sensor;
a processing unit; and
an output unit;
wherein the at least one temperature sensor is configured to acquire at least one temperature measurement at a first location of an operational device, and wherein the first location is in thermal contact with a second location of the operational device;
wherein the at least one temperature sensor is configured to provide the at least one temperature measurement to the processing unit;
wherein the processing unit is configured to select a simulated temperature distribution of the first location of the simulated device from a plurality of simulated temperature distributions of the first location of the simulated device, wherein the selection comprises a comparison of the at least one temperature measurement with the plurality of simulated temperature distributions of the first location, wherein the plurality of simulated temperature distributions of the first location each relate to a different situation with respect to simulated operation of the simulated device, and wherein for each of the different situations there is a correlation between a simulated temperature distribution of the first location and a simulated temperature at the second location of the simulated device;
wherein the processing unit is configured to determine that a hot spot exists or is developing at the second location of the operational device, and wherein the determination comprises utilization of the correlation between the simulated temperature distribution of the first location and the second location for the selected simulated temperature distribution of the first location of the simulated device; and
wherein the output unit is configured to output an indication of a fault at the second location of the operational device.

2. The system according to claim 1, wherein the at least one temperature sensor comprises one or more infrared cameras, one or more Surface Acoustic Wave sensor, or one or more RFID sensors.

3. The system according to claim 1, wherein the at least one temperature measurement comprises a plurality of temperature measurements, and wherein the plurality of temperature measurements were acquired at the same time.

4. The system according to claim 2, wherein the at least one temperature sensor is an infrared camera, and wherein the at least one temperature measurement comprises an infrared image of the first location.

5. The system according to claim 1, wherein the plurality of simulated temperature distributions are simulated in a process that comprises utilization of finite element analysis.

6. The system according to claim 1, wherein the correlation between the simulated temperature distribution of the first location and the simulated temperature at the second location of the simulated device for each of the different situations was determined through utilization of finite element analysis.

7. The system according to claim 1, wherein the comparison of the at least one temperature measurement with the plurality of simulated temperature distributions comprises utilization of a matrix norm or a machine learning algorithm implemented by the processing unit.

8. A method for monitoring a device, the method comprising:
a) acquiring by at least one temperature sensor at least one temperature measurement at a first location of an operational device, and wherein the first location is in thermal contact with a second location of the operational device;
b) providing the at least one temperature sensor to a processing unit;
c) selecting by the processing unit a simulated temperature distribution of the first location of the simulated device from a plurality of simulated temperature distributions of the first location of the simulated device, wherein the selecting comprises comparing the at least one temperature measurement with the plurality of simulated temperature distributions of the first location, wherein the plurality of simulated temperature distributions of the first location each relate to a different situation with respect to simulated operation of the simulated device, and wherein for each of the different situations there is a correlation between a simulated temperature distribution of the first location and a simulated temperature at the second location of the simulated device;
d) determining by the processing unit that a hot spot exists or is developing at the second location of the operational device, and wherein the determining comprises utilizing the correlation between the simulated temperature distribution of the first location and the second location for the selected simulated temperature distribution of the first location of the simulated device; and
e) outputting by an output unit an indication of a fault at the second location of the operational device.

9. The method according to claim 8, wherein the at least one temperature sensor comprises one or more infrared cameras, one or more Surface Acoustic Wave sensor, or one or more RFID sensors.

10. The method according to claim 8, wherein the at least one temperature measurement comprises a plurality of temperature measurements, and wherein the plurality of temperature measurements were acquired at the same time.

11. The method according to claim 8, wherein the at least one temperature sensor is an infrared camera, and wherein the at least one temperature measurement comprises an infrared image of the first location.

12. The method according to claim 8, wherein the plurality of simulated temperature distributions are simulated in a process that comprises utilization of finite element analysis.

13. The method according to claim 8, wherein the correlation between the simulated temperature distribution of the first location and the simulated temperature at the second location of the simulated device for each of the different situations was determined through utilization of finite element analysis.

14. The method according to claim 8, wherein the comparing the at least one temperature measurement with the plurality of simulated temperature distributions comprises utilizing a matrix norm or a machine learning algorithm implemented by the processing unit.
